(19) United States
(12) Patent Application Publication
(10) Pub. No.: US 2013/0185102 A1
(43) Pub. Date: Jul. 18, 2013

(54) Mobile eCommerce Ordering and Entertainment Management System and Method

(71) Applicant: Paul Grossi, Aliso Viejo, CA (US)

(72) Inventor: Paul Grossi, Aliso Viejo, CA (US)

(21) Appl. No.: 13/350,558

(22) Filed: Jan. 13, 2012

(51) Int. Cl. G06Q 30/06; G06Q 10/02; G06Q 30/02; G06Q 20/32

(52) U.S. Cl. 705/5; 705/27.1; 705/15

(57) ABSTRACT

Embodiments of the present invention provide a method for delivering items, comprising: upon a user launching a computer program on a device or visiting a proprietary mobile website using the device, presenting the user with a series of user-selectable events and participating venues on the device; passing menu items specific to the venue to the user's device based on criteria entered by the user; prompting the user to check out and confirm the items selected for purchase; prompting the user to enter credit card information; building a virtual order; splitting the virtual order into two streams including order detail information and credit card information; sending the order detail information to dispatch screens; automatically communicating order status to the user's device; and using the credit card information to process the order for payment.

### TECHNICAL FIELD

The present invention relates generally to mobile eCommerce applications, and more particularly, some embodiments relate to mobile eCommerce applications for ordering and delivering food, beverage, merchandise, tickets and media at stadiums, arenas, airports, amusement parks, and national parks through a unique supply chain management system.

### DESCRIPTION OF THE RELATED ART

Traditional concessions operations involving the sale of food, beverages and merchandise in large spectator venues typically involve patrons waiting in long lines for service or walking great distances to find adequate facilities. While most venues perform adequately, considering the vast number of patrons served within a condensed time frame, many attendees often miss crucial plays or part of the action during these unnecessary lines.

The current state of the industry still is essentially a brick-and-mortar, walk-up style kiosk system with personnel used as order takers, preparers and payment processors. Orders may he captured into a point of sale (POS) system, which then requires exchange of payment information (cash or credit card), and then order handling and bagging.

Some venues have trialed mobile ordering systems with limited success. Primarily, limited integration into house POS systems prevent these applications from operating as a true end-to-end automated system. Other mobile applications lack the management tools and controls to automate issue resolution, such as order tracking and status.

One proposed solution entails in-seat order taking that may be reserved for club level and suite guests. Such systems were developed by POS manufacturers and supported by concessionaires, and have been used for many years and are still in operation to this day. In-seat order taking may involve a personal wait staff taking orders and processing payments through a wireless POS terminal. One drawback is that this technology requires dedicated connectivity via WiFi and cannot operate on the cell network. As a result, infrastructure costs are high. In addition, many wireless terminals do not close the check at time of order entry and the wait staff is required to return to a home base to close the check, assemble the order and return with the product. This process is time consuming.

Another proposed solution is a text messaging order service. However, such systems suffer from a number of drawbacks. First, text messaging order services are not user friendly since they require the customer to type all order items. Second, there is no payment integration such that the wait staff is required to exchange cash or take the customer's credit card away for processing. Third, there is no POS integration such that the venue cannot track orders or inventory through the house POS system. Fourth, these systems use SMS (short messaging service) and can only handle 140 characters. Fifth, such systems lack a GUI (graphical user interface) and therefore rely solely on a patron's ability to correctly type a message.

Yet another proposed solution is a pick-up only service. This requires dedicated POS stations at the front of house. One drawback if that the customer is required to leave their seat to pick up at numerous stands, thus missing much of the action. Another drawback is that the use of dedicated POS terminals reduces the venue's ability to serve walk up clients as those terminals become dedicated to the pick-up service.

### BRIEF SUMMARY OF EMBODIMENTS OF THE INVENTION

Embodiments of the present invention provide mobile eCommerce applications for ordering and delivering food, beverage, merchandise, tickets and media at stadiums, arenas, airports, amusement parks, and national parks through a unique supply chain management system. Some embodiments entail fully automated order tracking via a web enabled “dispatch tool” to help manage orders, deliveries and issue resolution through constant monitoring of the order and automated SMS and email communication to the customer device.

Further embodiments of the present invention provide mobile eCommerce applications that directly address extended wait time issues by: (i) allowing a patron to order their goods and merchandise from their personal, web-enabled mobile device, such as a Smartphone, PDA, tablet or laptop PC; and (ii) having said items delivered directly to the patron's seat or location within the venue.

One embodiment of the invention is directed toward a method for delivering items, comprising: upon a user launching a computer program on a device or visiting a proprietary mobile website using the device, presenting the user with a series of user-selectable events and participating venues on the device; passing menu items specific to the venue to the user's device based on criteria entered by the user; prompting the user to check out and confirm the items selected for purchase; prompting the user to enter credit card information; building a virtual order; splitting the virtual order into two streams including order detail information and credit card information; sending the order detail information to dispatch screens; and using the credit card information to process the order for payment.

Another embodiment of the invention is directed toward a system for delivering items, comprising: a processor; and at least one computer program residing on the processor; wherein the computer program is stored on a non-transitory computer readable medium having computer executable program code embodied thereon, the computer executable program code configured to cause a server to: present the user with a series of user-selectable events and participating venues on a user device; pass menu items specific to the venue to the user's device based on criteria entered by the user; prompt the user to check out and confirm the items selected for purchase; prompt the user to enter credit card information; build a virtual order; split the virtual order into two streams including order detail information and credit card information; send the order detail information to dispatch screens; and use the credit card information to process the order for payment.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

FIG. 1 is a diagram depicting a system and method for ordering and delivering food, beverages and other products, in accordance with an embodiment of the invention.

FIG. 2 is a diagram illustrating an example computing module for implementing various embodiments of the invention.

The figures are not intended to be exhaustive or to limit the invention to the precise form disclosed. It should be understood that the invention can be practiced with modification and alteration, and that the invention be limited only by the claims and the equivalents thereof

### DETAILED DESCRIPTION OF THE EMBODIMENTS OF THE INVENTION

Embodiments of the present invention are directed toward mobile eCommerce applications for ordering and delivering food, beverage, merchandise, tickets and media at stadiums, arenas, airports, amusement parks, and national parks through a unique supply chain management system.

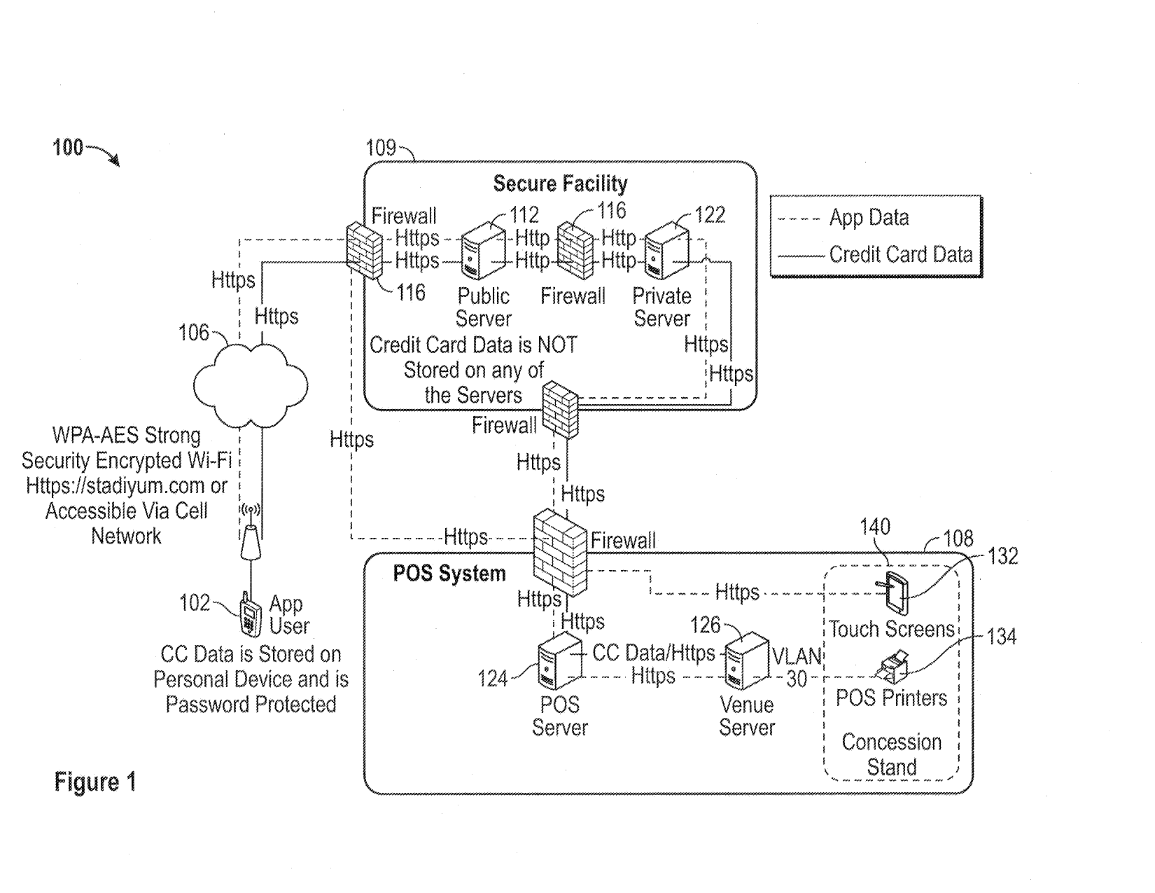

Referring to FIG. 1, a system and method for ordering and delivering food, beverages and other products will now he described. The system 100 may comprise a mobile web-enabled application, Apple iOS or Android application that is installed on a user's personal web-enabled phone (i.e., device 102) and is configured to communicate with a POS system 108 by way of a secure facility such as data center 109. The user's credit card data is stored in the device 102 and may be password protected. The credit card information is not stored on any of the servers 112. In the illustrated embodiment, the data center 109 includes a public server 112 in communication with device 102 and a private data center server 122 in communication with public server 102. A series of firewalls 116 may be provided, for example, between the device 102 and the public server 116, between the public server 112 and the private server 122, and between the data center 109 and the POS system 108. The data center server 122 is capable of providing various information and menu items for selection by the user on device 102. In some embodiments, the information and menu items include a list of events and venues hosting the events, event prices, event layout, seating arrangement, menu items such as food, beverages and other products, as well as advertising. The advertising may be general advertising (i.e., not venue-specific), venue-specific advertising, or a combination of both.

With further reference to FIG. 1, the POS system 108 includes a private POS server 124 in communication with data center server 122. The PUS server 124 provides two-way communication and acts as a translator between data center server 122 and venue server 128 such that the POS server 124 is also in communication with dispatch terminals featuring dispatch screens 132 (e.g., touch screens) and POS printers 134 located at the concession stand 140. The information and menu items that reside on data center server 122 are periodically synched with the POS server 124 such that the servers contain consistent data. The user's credit card data is stored in the device 102 and may be password protected. The credit card information is never stored on any of the servers 112, 122, 124, 128.

In operation, an application user launches the application on device 102 or visits the mobile optimized web site 106 (e.g., WPA-AES Strong Security Encrypted Wi-Fi https://stadiyum.com) using device 102. The data center server 122 then presents the user with a series of user-selectable events and participating venues on device 102 such that the user may select the events and venues they are attending. More particularly, user-selected information is passed through public server 112 and firewalls 116 to data center server 122, which then passes back to the device 102 pertinent information specific to that venue/location. Venue-specific and/or general advertising is then prepared by the data center server 122 and sent to the application on the user's device 102. The event layout and seating arrangement for the selected event is also prepared on the data center server 122, awaiting seat selection by the user. In addition, menu items specific to the event are also prepared on the data center server 122, awaiting the user to make menu selections. The user is then prompted to input their seat location(s) for identification.

Based on criteria entered by the user including the event and venue information, menu items specific to the venue are passed to the user's device 102 such that the user can then select goods to be ordered off the menu. Once the user's shopping basket is full, they are required to check out and confirm the items selected for purchase. The user is then prompted to enter credit card information. As stated hereinabove, the credit card information may pass through, but is not stored, on any of the servers 112, 122, 124, 128. The user may also be prompted to enter personal information, such as cell phone number and email address. Next, the user is prompted to confirm and place the order. The credit card information and personal information is passed to data center server 122 via an https connection, and one or more API's build the virtual order to be passed to the POS server 124 physically located at the venue. The POS server 124 then splits this information into two streams: (i) order detail information and (ii) credit card information.

With continued reference to FIG. 1, order detail information is sent to specific web-enabled dispatch screens 132 that are strategically placed around the venue at concessions stands 140 and/or food preparation kitchens. This information is used by kitchen staff to prepare the order as well as by delivery staff to deliver orders. The order detail information and credit card information is also captured by the POS system 108 for inventory control. The credit card info is passed through the gateway and processed for payment, while the POS server 124 sends the order detail to POS printers 134 that are set up beside the Dispatch Terminals in the Concession Stands. Once an order is received and verified by the POS system 108 and credit card processing system, an order confirmation is then sent back to the user's device 102.

In some embodiments, the POS server 124 automatically communicates order status to the customer's device 102 when personnel enter information into a dispatch screen 132. Specifically, an automatically generated text and/or email message is sent to the user's device 102 based on the issue being resolved. By way of example, the message may be: (i) Order Placed, (ii) Order Ready, (iii) Order Pick up, (iv) Order Delivered, (v) Order Issue 1—ID not provided, (vi) Order Issue 2—items mishandled, (vii) Order Issue 3—customer not present at time of order, (viii) Order Issue 4—incorrect seat location entered, or (ix) any other suitable message. The customer is then automatically notified by an automatically generated SMS or email message where to seek customer service if an Order Issue message is received.

According to some embodiments, the device 102 retains the past 10 items in a separate section of the application that may be referred to as the “order history.” The application calculates an estimated processing and delivery time for the order and displays the results on the device 102, setting an automatic expectation regarding order delivery time. On the back end at the concession stand, the order is retrieved by a staff member, who then claims the order through a secure 4-digit pin, collects the items and delivers to the patron. The information is then sent back to data center 109, which prompts an automated SMS message that is sent to the device 102 notifying the user that the order is out for delivery.

When the delivery staff member returns to the dispatch terminal touch screen 132, the staff member is prompted to enter a secure PIN. The system recognizes whether the delivery staff member still has open orders and requests the delivery staff member to complete order entry. If the delivery staff member has successfully delivered their orders, they select “YES.” This closes the order, sends an automated receipt to the user's device 102 via email and sends an SMS message to the user's device to thank them for their patronage. If the delivery staff member unsuccessfully dispatches an order, they are requested to provide an explanation from a list of possible exceptions. Once an exception has been selected, the system automatically notifies the patron via SMS of the order issue and provides details to resolve the situation (i.e., pick up order at location X, or please contact customer support at Y).

According to further embodiments, the data center server 122 can send a convenience fee, a delivery fee, or both, to the user's device 102. Such fees can be assigned to different sections and have sponsorship/promotion opportunities associated therewith. The fee may comprise a simple dollar amount, a percentage of the transaction, or a custom sliding scale fee. Fee options can be passed to the POS server 124 as a Convenience Fee or a Delivery with the option to combine the fees, issue more than one fee or eliminate the fees, prior to being passed to the POS server 124.

Much like the food and beverage and entertainment options available to users in certain sections, the fees structure is generated from the customer's section/row/seat identifier. This allows the venue to create promotions based on the fee structure implemented per section. Club level and Suites typically do not impose an additional fee since ticket prices are already at a premium. Accordingly, these fields would be set to $0. In operation, the system 100 calculates the fee structure based on the program implemented, passes the fee to the POS system and passes this information back to the user's device 102. When using a sliding scale, a minimum and maximum is set while different fee percentages are imposed based on incremental values of the total order. For example, an order of $5 or less receives a $1 straight fee, whereas an order of $5.01 to $10 receives a 15% fee, while an order of $10.01 to $20 receives a 12% fee, etc. There might also be a cap of a $4.50 fee for anything $30 and above.

In accordance with various embodiments of the invention, the mobile web-enabled application described herein can be used in the following market segments: (i) airports (e.g., for gate to gate delivery, in-flight ordering prior to landing, airport restaurant pick up); (ii) bars/clubs (e.g., patrons can order items from anywhere within the establishment and pick up at a side bar when prepared and prompted, thus eliminating lengthy lines at the counter and allowing a remote wait staff to process orders without returning to side bar for pick up and delivery); (iii) fast food establishments; (iv) movie theatres; (v) concert halls; (vi) amusement parks; and (vii) other market segments.

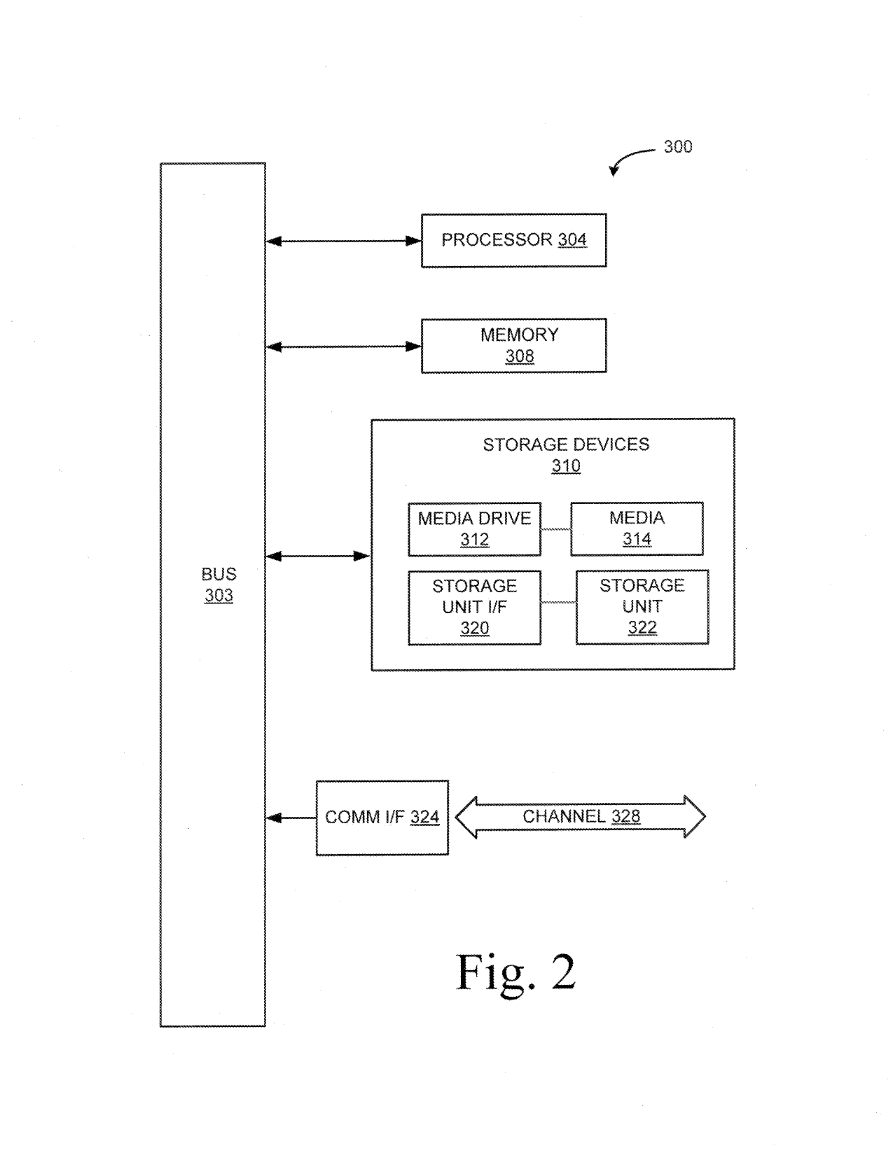

As used herein, the term “module” might describe a given unit of functionality that can be performed in accordance with one or more embodiments of the present invention. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the invention are implemented in whole or in part using software, in one embodiment, these software elements can be implemented to operate with a computing or processing module capable of carrying out the functionality described with respect thereto. One such example computing module is shown in FIG. 2. Various embodiments are described in terms of this example-computing module 300. After reading this description, it will become apparent to a person skilled in the relevant art how to implement the invention using other computing modules or architectures.

Referring now to FIG. 2, computing module 300 may represent, for example, computing or processing capabilities found within desktop, laptop and notebook computers; hand-held computing devices (PDA's, smart phones, cell phones, palmtops, etc.); mainframes, supercomputers, workstations or servers; or any other type of special-purpose or general-purpose computing devices as may be desirable or appropriate for a given application or environment. Computing module 300 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 300 might include, for example, one or more processors, controllers, control modules, or other processing devices, such as a processor 304. Processor 304 might be implemented using a general-purpose or special-purpose processing engine such as, for example, a microprocessor, controller, or other control logic. In the illustrated example, processor 304 is connected to a bus 303, although any communication medium can be used to facilitate interaction with other components of computing module 300 or to communicate externally.

Computing module 300 might also include one or more memory modules, simply referred to herein as main memory 308. For example, preferably random access memory (RAM) or other dynamic memory, might be used for storing information and instructions to be executed by processor 304. Main memory 308 might also be used for storing temporary variables or other intermediate information during execution of instructions to be executed by processor 304. Computing module 300 might likewise include a read only memory (“ROM”) or other static storage device coupled to bus 303 for storing static information and instructions for processor 304.

The computing module 300 might also include one or more various forms of information storage mechanism 310, which might include, for example, a media drive 312 and a storage unit interface 320. The media drive 312 might include a drive or other mechanism to support fixed or removable storage media 314. For example, a hard disk drive, a floppy disk drive, a magnetic tape drive, an optical disk drive, a CD, DVD or Blu-ray drive (R or RW), or other removable or fixed media drive might be provided. Accordingly, storage media 314 might include, for example, a hard disk, a floppy disk, magnetic tape, cartridge, optical disk, a CD, DVD or Blu-ray, or other fixed or removable medium that is read by, written to or accessed by media drive 312. As these examples illustrate, the storage media 314 can include a computer usable storage medium having stored therein computer software or data.

In alternative embodiments, information storage mechanism 310 might include other similar instrumentalities for allowing computer programs or other instructions or data to be loaded into computing module 300. Such instrumentalities might include, for example, a fixed or removable storage unit 322 and an interface 320. Examples of such storage units 322 and interfaces 320 can include a program cartridge and cartridge interface, a removable memory (for example, a flash memory or other removable memory module) and memory slot, a PCMCIA slot and card, and other fixed or removable storage units 322 and interfaces 320 that allow software and data to be transferred from the storage unit 322 to computing module 300.

Computing module 300 might also include a communications interface 324. Communications interface 324 might be used to allow software and data to be transferred between computing module 300 and external devices. Examples of communications interface 324 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 324 might typically he carried on signals, which can be electronic, electromagnetic (which includes optical) or other signals capable of being exchanged by a given communications interface 324. These signals might he provided to communications interface 324 via a channel 328. This channel 328 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to media such as, for example, memory 308, storage unit 320, media 314, and channel 328. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 300 to perform features or functions of the present invention as discussed herein.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps arc presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should he read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, nonnal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “hut not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

1. A method for delivering items, comprising:
upon a user launching a computer program on a device or visiting a proprietary mobile website using the device, presenting the user with a series of user-selectable events and participating venues on the device;
passing menu items specific to the venue to the user's device based on criteria entered by the user;
prompting the user to check out and confirm the items selected for purchase;
prompting the user to enter credit card information;
building a virtual order;
splitting the virtual order into two streams including order detail information and credit card information;
sending the order detail information to dispatch screens;
automatically communicating order status to the user's device; and
using the credit card information to process the order for payment.

2. The method of claim 1, wherein the computer program comprises a mobile web-enabled application, Apple iOS or Android application that is installed on the device and is configured to communicate with a POS system by way of a secure facility.

3. The method of claim 1, wherein the credit card information is only stored on the device.

4. The method of claim 1, wherein presenting the user with a series of user-selectable events and participating venues on the device comprises:
passing user-selected information through a public server and at least one firewall to a data center server, which then passes back to the device pertinent information specific to that venue/location;
preparing venue-specific or general advertising and sending this to the computer program;
preparing event layout and seating arrangement for the selected event on the data center server for seat selection by the user; and
preparing menu items specific to the event on the data center server for selection by the user.

5. The method of claim 1, wherein building the order comprises:
passing the user's credit card information and personal information to the data center server;
using one or more API's to build the virtual order; and
passing the virtual order to the POS server physically located at the venue.

6. The method of claim 1, wherein the dispatch screens comprise web-enabled dispatch screens that are strategically placed around the venue at concessions stands or food preparation kitchens.

7. The method of claim 1, wherein the order detail information is used by kitchen staff to prepare the order as well as by delivery staff to deliver the order.

8. The method of claim 1, further comprising capturing the order detail information and credit card information for inventory control.

9. The method of claim 1, further comprising sending an order confirmation back to the user's device.

10. The method of claim 1, further comprising calculating an estimated processing and delivery time for the order and displaying the results on the device.

11. The method of claim 1, further comprising sending a convenience fee, a delivery fee, or both, to the user's device.

12. A system for delivering items, comprising:
a processor; and
at least one computer program residing on the processor;
wherein the computer program is stored on a non-transitory computer readable medium having computer executable program code embodied thereon, the computer executable program code configured to cause a server to:
present the user with a series of user-selectable events and participating venues on a user device;
pass menu items specific to the venue to the user's device based on criteria entered by the user;
prompt the user to check out and confirm the items selected for purchase;
prompt the user to enter credit card information;
build a virtual order;
split the virtual order into two streams including order detail information and credit card information;
send the order detail information to dispatch screens;
automatically communicate order status to the user's device; and
use the credit card information to process the order for payment.

13. The system of claim 12, wherein the computer program comprises a mobile web-enabled application, Apple iOS or Android application that is installed on the device and is configured to communicate with a POS system by way of a secure facility.

14. The system of claim 12, wherein the credit card information is only stored on the device.

15. The system of claim 12, wherein presenting the user with a series of user-selectable events and participating venues on the device comprises:
passing user-selected information through a public server and at least one firewall to a data center server, which then passes back to the device pertinent information specific to that venue/location;
preparing venue-specific or general advertising and sending this to the application on the user's device;
preparing event layout and seating arrangement for the selected event on the data center server for seat selection by the user; and
preparing menu items specific to the event on the data center server for selection by the user.

16. The system of claim 12, wherein building the order comprises:
passing the user's credit card information and personal information to the data center server;
using one or more API's to build the virtual order; and
passing the virtual order to the POS server physically located at the venue.

17. The system of claim 12, wherein the dispatch screens comprise web-enabled dispatch screens that are strategically placed around the venue at concessions stands or food preparation kitchens.

18. The system of claim 12, wherein the order detail information is used by kitchen staff to prepare the order as well as by delivery staff to deliver the order.

19. The system of claim 12, wherein the computer executable program code is further configured to cause the server to capture the order detail information and credit card information for inventory control.

20. The system of claim 12, wherein the computer executable program code is further configured to cause the server to send an order confirmation back to the user's device.

21. The system of claim 12, wherein the computer executable program code is further configured to cause the server to calculate an estimated processing and delivery time for the order and display the results on the device.

22. The system of claim 12, wherein the computer executable program code is further configured to cause the server to send a convenience fee, a delivery fee, or both, to the user's device.
